(19) United States
(12) Patent Application Publication
(10) Pub. No.: US 2012/0195049 A1
(43) Pub. Date: Aug. 2, 2012

(54) LAMP

(75) Inventors: Shih-Chin CHOU, Hsinchu (TW); Chun-Ming LAI, Hsinchu (TW); He-Shun YANG, Hsinchu (TW)

(73) Assignee: LEXTAR ELECTRONICS CORP., Hsinchu (TW)

(21) Appl. No.: 13/346,545

(22) Filed: Jan. 9, 2012

Related U.S. Application Data
(60) Provisional application No. 61/438,160, filed on Jan. 31, 2011.

(51) Int. Cl. F21V 29/00; F21V 5/04

(52) U.S. Cl. 362/294; 362/311.01; 362/311.06

(57) ABSTRACT

A lamp module is provided, including an insulative member, a cover lens connected to the insulative member, and a light module disposed between the insulative member and the cover lens. The light module can emit light through the cover lens for illumination.

### CROSS REFERENCE TO RELATED APPLICATIONS

This Application claims priority from provisional patent application Ser. No. 61/438,160, filed on Jan. 31, 2011, the entirety of which is incorporated by reference herein.

### BACKGROUND OF THE INVENTION

1. Field of the Invention

This application relates in general to a lamp and in particular to an LED lamp module with low weight and high safety.

2. Description of the Related Art

In the recent years, LEDs have been increasingly used in general illumination. FIG. 1 shows a conventional LED lamp primarily comprising a light module (L), a circuit unit (C), a tube (T), and two housings (H). As shown in FIG. 1, the light module (L) and circuit unit (C) are electrically connected to the terminals (P) which extend outwardly from the housings (H). During assembly, the light module (L) and driving unit (D) are accommodated in the tube (T).

To prevent overheat of the light module (L), the tube (T) may be formed in one piece by aluminum extrusion for rapid heat dissipation. However, the aluminum tube (T) may electrically contact the circuit unit (C) and increase the risk of shock or injury to persons.

### BRIEF SUMMARY OF INVENTION

This application provides a lamp including an insulative member, a cover lens connected to the insulative member, and a light module disposed between the insulative member and the cover lens. The light module can emit light through the cover lens for illumination.

### BRIEF DESCRIPTION OF DRAWINGS

The invention can be more fully understood by reading the subsequent detailed description and examples with references made to the accompanying drawings, wherein:

FIG. 1 is an exploded diagram of a conventional LED lamp; and

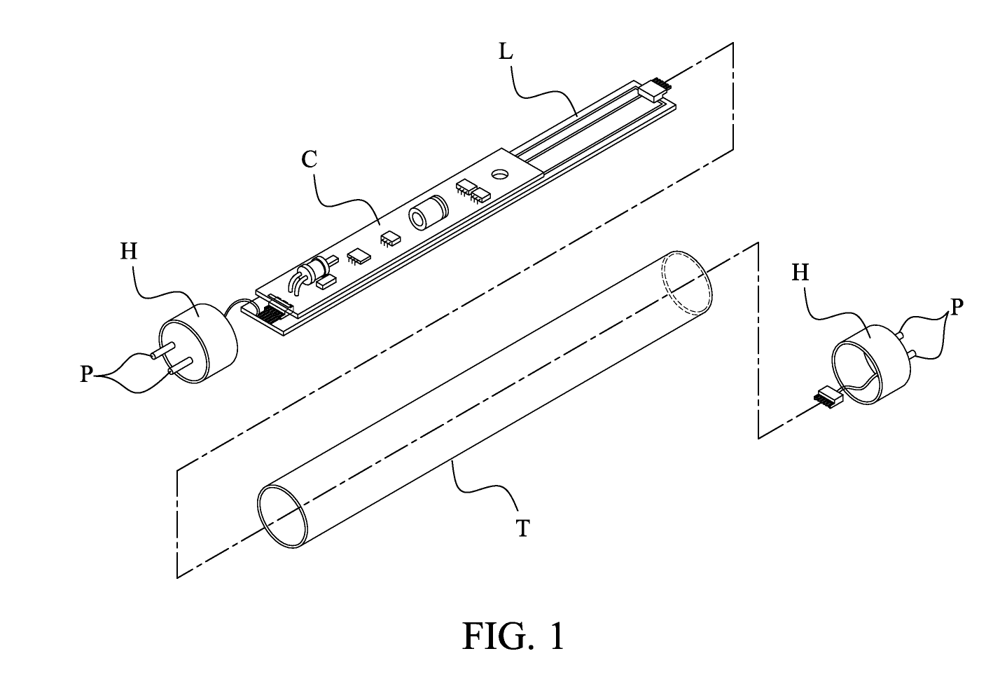

FIG. 2 is an exploded diagram of a lamp according to an embodiment of the invention.

### DETAILED DESCRIPTION OF INVENTION

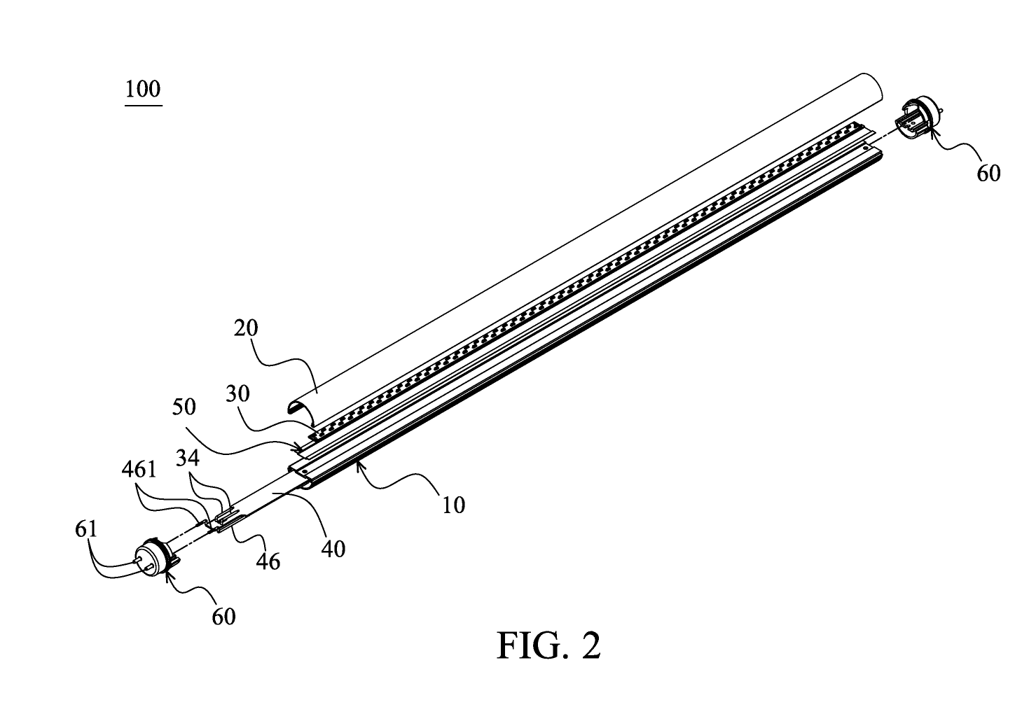

Referring to FIG. 2, an embodiment of a lamp (100) primarily comprises an insulative member (10), a cover lens (20) connected to the insulative member (10), a light module (30) disposed between the insulative member (10) and the cover lens (20), a circuit unit (40) received in the insulative member (10), a thermal member (50) disposed between the light module (30) and the insulative member (10), and two housing (60) with at least a terminal (61) projecting therefrom. As shown in FIG. 2, the insulative member (10) and the cover lens (20) form a round hollow tube for receiving the light module (30). The cover lens (20) may comprise a transparent curved structure, and the light module (30) may comprise a plurality of LEDs which emit light through the cover lens (20) for illumination.

In this embodiment, the insulative member (10) may comprise Polycarbonate (PC) or other insulative material, thus reducing the risk of shock or injury to persons. Additionally, the insulative member (10) may comprise a curved structure and a plurality of protrusions formed on an outer surface thereof, so as to increase area of the outer surface for rapid heat dissipation.

In FIG. 2, the light module (30) and the circuit unit (40) can be electrically connected to each other through the wires (34). Moreover, the circuit unit (40) and the terminal (61) can be electrically connected through the wires (46). In some embodiments, the circuit unit (40) may comprise a transformer for driving the light module (30).

The two housings (60) are provided at both ends of the lamp (100). The terminals (61) respectively projects from the housings (60) in opposite directions. During assembly, the housings (60) are joined with the insulative member (10) and the cover lens (20), so as to form a closed space of the round tube. Specifically, since each of the terminals (61) has a hollow structure, the wires (46) can be press-fitted into the terminals (61) for robust and easy connection.

The thermal member (50) is disposed between the light module (30) and the insulative member (10). Heat generated from the light module (30) can be directly conducted through thermal member (50) and transferred to the insulative member (10), thus facilitating rapid heat dissipation of the lamp. Additionally, since the insulative member (10) is made of insulative material, such as Polycarbonate (PC), it can be much lighter than conventional aluminum tubes to reduce the weight of the lamp.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A lamp (100), comprising:
an insulative member (10);
a cover lens (20), connected to the insulative member (10); and
a light module (30), disposed between the insulative member (10) and the cover lens (20), wherein the light module (30) emits light through the cover lens (20) for illumination.

2. The lamp (100) as claimed in claim 1, wherein the lamp (100) further comprises a circuit unit (40) received in the insulative member (10), a terminal (61) disposed at an end of the lamp (100), and a wire (46) electrically connecting the circuit unit (40) with the terminal (61).

3. The lamp (100) as claimed in claim 2, wherein the terminal (61) has a hollow structure, and the wire (46) is press-fitted into the terminal (61).

4. The lamp (100) as claimed in claim 2, wherein the lamp (100) further comprises a housing (60) connected to the insulative member (10) and the cover lens (20), and the terminal (61) projects from the housing (60).

5. The lamp (100) as claimed in claim 2, wherein the circuit unit (40) is electrically connected with the light module (30).

6. The lamp (100) as claimed in claim 1, wherein the insulative member (10) has a curved structure and a plurality of protrusions formed on an outer surface of the curved structure for heat dissipation.

7. The lamp (100) as claimed in claim 1, wherein the cover lens (20) comprises a transparent curved structure.

8. The lamp (100) as claimed in claim 1, wherein the lamp (100) further comprises a thermal member (50) disposed between the light module (30) and the insulative member (10), to transfer heat from the light module (30) to the insulative member (10).

9. The lamp (100) as claimed in claim 1, wherein the insulative member (10) and the cover lens (20) form a round hollow tube for receiving the light module (30).

10. The lamp (100) as claimed in claim 1, wherein the insulative member (10) comprises Polycarbonate (PC).
